(19) United States
(12) Patent Application Publication
(10) Pub. No.: US 2025/0272738 A1
(43) Pub. Date: Aug. 28, 2025

(54) SYSTEM FOR PRESENTING ITEMS IN ONLINE ENVIRONMENT BASED ON PREVIOUS ITEM SELECTIONS

(71) Applicant: Target Brands, Inc., Minneapolis, MN (US)

(72) Inventors: RANKYUNG PARK, Minneapolis, MN (US); AMIT PANDE, Minneapolis, MN (US); DAVID RELYEA, Seattle, WA (US); PUSHKAR CHENNU, San Francisco, CA (US); PRATHYUSHA KANMANTH REDDY, Richardson, TX (US)

(21) Appl. No.: 19/065,141

(22) Filed: Feb. 27, 2025

Related U.S. Application Data
(60) Provisional application No. 63/558,642, filed on Feb. 27, 2024.

(51) Int. Cl. G06Q 30/0601

(52) U.S. Cl. CPC G06Q 30/0631; G06Q 30/0641

(57) ABSTRACT

Methods and systems for predicting relevant items to be presented to a user in an online environment. The methods and systems described herein generate models based on previous item selections to determine an overall model useable to generate item recommendations. In some examples, an item-level and category-level Hawkes process may be used, modeling a combination of an exponential distribution for short-history effects and Gaussian mixture probabilities to account for extended time period effects.

### CROSS-REFERENCE TO RELATED APPLICATIONS

The present application claims priority from U.S. Provisional Patent Application No. 63/558,642, filed on Feb. 27, 2024, the disclosure of which is hereby incorporated by reference in its entirety.

### BACKGROUND

In a retail environment, a large percentage of items that are sold, in aggregate, are repeated purchases, and in particular, purchases made by a user on a regular or semi-regular basis. In an online retail environment, a user may be presented with a selection of previous purchases, e.g., on a front page of a website, so that user may easily select items that the user purchased in the past. However, often the selection of items presented to that user can be inaccurate as to what the user is seeking, especially at a particular time. The item may be one that is not of interest to the user, or may be a suggestion to repurchase something at a timing that is illogical (e.g., a recommendation to repurchase an item immediately upon the user purchasing the item initially).

Personalized product recommendations allow retailers to enhance their customers' shopping experiences. By analyzing customer data, retailers can identify patterns and preferences that help them curate item assortments, improve customer satisfaction, and increase sales. Furthermore, personalized recommendations demonstrate to customers that the retailer understands and cares about their individual needs, fostering trust and loyalty.

To help customers build their baskets easily, retailers often use Next Basket Recommendation (NBR) algorithms. A subset of these algorithms are called Buy It Again (BIA) algorithms where the task is to sample items from a customer's purchase history which they are likely to want to repurchase in the near term. Many BIA models use neural networks or variants to predict item repurchase probabilities. However, large retailers have millions of items and customers, a scale which can lead to issues with underfitting and scaling. Additionally, significant computational requirements are introduced by the large set of records and need for adequate training of such neural networks. Accordingly, computationally advantageous solutions to provide such purchase recommendations are sought.

### SUMMARY

In general terms, the present disclosure relates to predicting relevant items to be presented to a user in an online environment using a simplified model based on aggregated historical customer data. Using a simplified model allows for reduced computational resource requirements and improved scalability, while maintaining the accuracy of more complex algorithms.

In a first aspect, a method of generating an item recommendation to a user comprises identifying sales associated with a retail customer identified as a visitor of a retail website. The method includes classifying these sales into item level sales data. For each item included in the item level sales data, the method includes identifying an item category. For each item included in the item level sales data, the method includes determining an overall item excitation score. Determining the overall item excitation score includes: determining an item-level excitation score including an item short-term repurchase factor modeled as an exponential distribution and an item long-term repurchase factor modeled as a Gaussian mixture distribution; determining a category-level excitation score including a category short-term repurchase factor modeled as an exponential distribution and a category long-term repurchase factor modeled as a Gaussian mixture distribution; and determining the overall item excitation score for the item based on one or more of the item-level excitation score and the category-level excitation score. The method then includes ranking a plurality of generated overall item excitation scores, each associated with a different item from among the item level sales data. Then, one or more of the plurality of items included in the retail item collection is selected based on the ranked overall item excitation scores. Finally, the one or more of the plurality of items is displayed within a retail website for purchase by the retail customer.

In a second aspect, a system is designed for generating an item recommendation to a user. The system comprises a data repository configured to store sales data associated with a retail customer identified as a visitor of a retail website. It also includes a recommendation system in data communication with the data repository and a plurality of client computing devices. The recommendation system is configured to classify the sales data into item level sales data. For each item included in the item level sales data, the system is configured to identify an item category. For each item included in the item level sales data, the system is also configured to determine an overall item excitation score. Determining the overall item excitation score includes: determining an item-level excitation score including an item short-term repurchase factor modeled as an exponential distribution and an item long-term repurchase factor modeled as a Gaussian mixture distribution; determining a category-level excitation score including a category short-term repurchase factor modeled as an exponential distribution and a category long-term repurchase factor modeled as a Gaussian mixture distribution; and determining the overall item excitation score for the item based on one or more of the item-level excitation score and the category-level excitation score. The system is also configured to rank a plurality of overall item excitation scores, each associated with a different item from among the item level sales data. Based on the ranked overall item excitation scores, the system selects one or more of the plurality of items included in the retail item collection. The one or more of the plurality of items are displayed within a retail website for purchase by the retail customer.

In a third aspect, a method of generating an item recommendation to a user comprises identifying sales associated with a retail customer identified as a visitor of a retail website. The method includes classifying the sales into item level sales data, wherein classifying the sales into item level sales data further includes applying a filter to eliminate items with low repurchase rates. For each item included in the item level sales data, the method determines an item-level excitation score based on historical sales data across all retail customers of a retail enterprise. Determining the item-level excitation score includes determining item short-term repurchase factor modeled as an exponential distribution and an item long-term repurchase factor modeled as a Gaussian mixture distribution. The method ranks a plurality of generated item-level excitation scores, each associated with a different item from among the item level sales data. Based on the ranked item-level excitation scores; the method selects one or more of the plurality of items included in the retail item collection. The one or more of the plurality of items are displayed within a retail website for purchase by the retail customer.

### BRIEF DESCRIPTION OF THE DRAWINGS

FIG. 1 illustrates an example web server environment in which aspects of the present disclosure may be implemented.

FIG. 2 is a flow chart of an example method performable by the recommendation system.

FIG. 3 is a flowchart of an example method of determining an overall item excitation score.

FIG. 4 is a block diagram of an example architecture of aspects of a recommendation system usable within a retail enterprise.

FIG. 5 illustrates modeling repurchase probability for an item, according to an example embodiment.

FIG. 6 illustrates modeling repurchase probability for an item, according to an example embodiment.

FIG. 7 illustrates a user interface, according to an example embodiment.

FIG. 8 illustrates a user interface, according to an example embodiment.

FIG. 9 illustrates an example computing system with which aspects of the present disclosure may be implemented.

### DETAILED DESCRIPTION

As briefly described above, embodiments of the present invention are directed to predicting relevant items to be presented to a user in an online environment.

In the retail context, the prediction of items can take the form of a shopping basket prediction system, where, based on past purchases of a customer, the next shopping basket of that customer is predicted. This looks at specific items, and item classes, to determine which specific classes of items has been purchased in the past (with some degree of regularity) and this is then used to predict shopping behavior for at least “frequent” items (e.g., items purchased more than X times in the past predetermined amount of time).

Such an arrangement has particular advantages, especially in a retail environment, and in particular in an online retail environment for a retailer having complementary physical store sales. With continued integration of online and in-store sales systems, as well as blended delivery models (e.g., online purchase and in-store pickup, in-store order for delivery, etc.) accurate capture of information and accurate recommendations can allow an in-store shopper with limited time to devote that time to browsing “elective” items, rather than these recurring purchase items likely to be included on the user's shopping list, and which require time to select/gather. By allowing users to quickly select items in an online context, a store service could be used to order and either deliver items or have those items available for pick-up, freeing the user/customer's time for browsing other items.

In particular, the methods and systems described herein generate models based on previous item selections that are associated with an overall set of users to determine an overall model useable to generate item recommendations. In some examples, an item-level and category-level Hawkes process may be used, modeling a combination of an exponential distribution for short-history effects and Gaussian mixture probabilities to account for extended time period effects.

In some example implementations, the modeling described herein is directed to the behavior of a general purchasing population, rather than requiring highly customized recommendation generation for a particular user's purchasing preferences and cadence, which may be highly computationally complex for large organizations. Furthermore, the modeling described herein avoids use of collaborative filtering that might otherwise be applied to large populations, in order to improve computational resource usage. Specifically, by reducing collaborative filtering, time complexity is reduced, and scalability is increased, while accuracy and responsiveness of the model remain comparable if not better than other approaches. This enables a retail organization to scale such item recommendations greatly within the context of a large collection of item candidates for recommendation.

In some example implementations, the use of early-stage filtering to eliminate items with low repurchase rates from the dataset can further increase the scalability and computational efficiency of the modeling described herein. For example, because the modeling described herein can determine recommendations on an item-by-item basis, by applying one or more item or category-level filters, based on purchasing patterns shown across all customers, especially early in the process, the model's speed and capacity to generate item recommendation outputs can be further enhanced.

In some implementations, an item repurchase rate can be determined such that an item may be recommended to a customer at a frequency according to an the repurchase rate associated with the item. For example, an item repurchase rate can be determined by evaluating an item-level excitation score. In some implementations, an item excitation score can include a determining item short-term repurchase factor modeled as modeled as an exponential distribution. In other implementations, determining an item excitation score can include determining item long-term repurchase factor modeled as a Gaussian mixture distribution. In some embodiments determining an item-level excitation score can include combining an item short-term repurchase factor and an item long-term repurchase factor.

In some example implementations, items can be sorted into predetermined categories with associated repurchase rates. The category repurchase rate may be based on an average of the repurchase rates of all customers, across all items comprising the category. In this manner, items may be recommended at a frequency according to the repurchase rate associated with the item's predetermined category thus further enhancing the efficiency and scalability of the system while maintaining accuracy.

In some example implementations, a category repurchase rate and an item repurchase rate can both be determined, across all users, such that an item may be recommended to a customer at an overall repurchase rate that accounts for both the category repurchase rate and the item repurchase rate to further pinpoint repurchase accuracy while maintaining efficiency and scalability of the system.

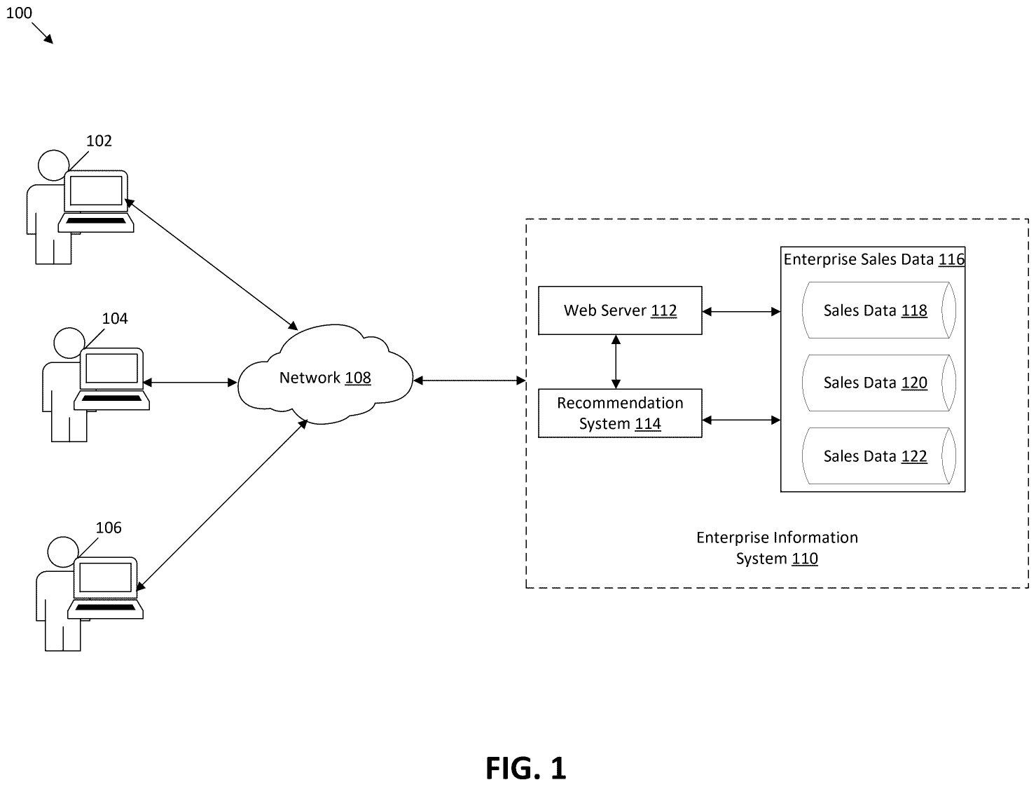

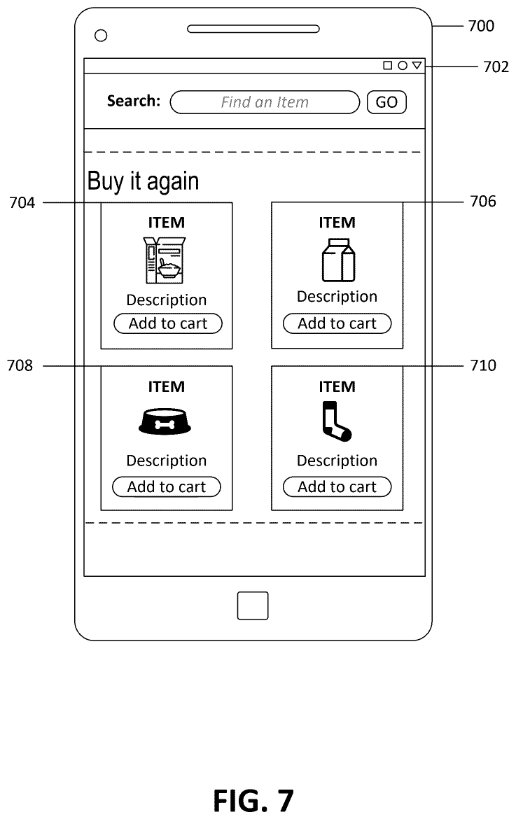

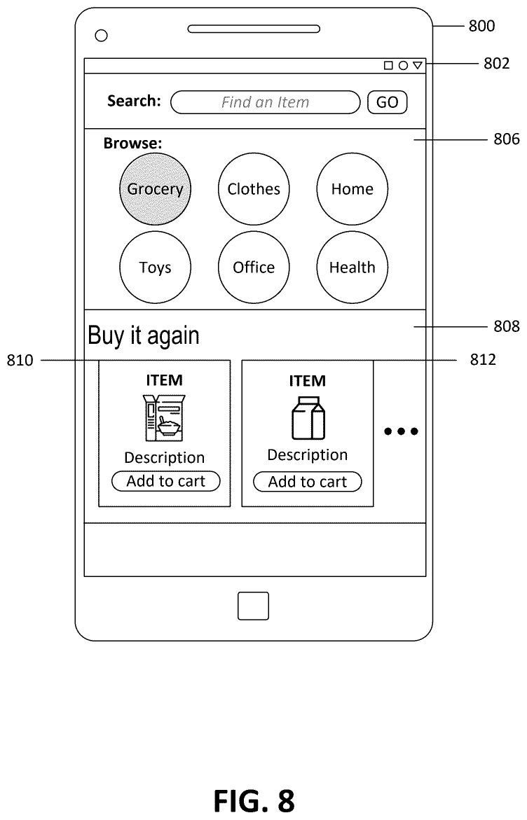

Referring to FIG. 1, an example web server environment 100 is shown in which aspects of the present disclosure may be implemented. In some embodiments, the web server environment 100 is a web server for presenting items based on previous item selections. In some examples, previous item selections can be previous item purchases. The environment includes a web server 112, recommendation system 114, and an enterprise sales database 116 that are part of an enterprise information system 110. The enterprise information system 110 may be accessible via network 108 by a variety of users 102, 104, and 106 using various types of computing devices as described with further detail in reference to FIGS. 7 and 8.

The users 102, 104, 106 may be associated with login credentials. For example, the users 102, 104, and 106 may be retail customers identified as a visitor of a retail website or mobile application.

The network 108 can include any combination of local area networks (LANs), wide area networks (WANs), and the Internet, enabling communication between the various system components using standard networking protocols.

The enterprise information system 110 provides backend services and data management capabilities that support the content server system's ability to maintain user credentials, process recommended items to be displayed, track item recommendation performance, and manage item recommendation lifecycle states.

The web server 112 operates within the enterprise information system 110 to manage content to be displayed to the users. In some embodiments, the web server 112 is configured to receive requests for web content from a plurality of client computing devices. In some embodiments, the client computing devices are associated with user credentials such that sales associated with the user can be identified. In some implementations, the web server 112 is in data communication with the recommendation system 114. In some implementations, the web server 112 is in further data communication with one or more data repositories such as the enterprise sales database 116.

The enterprise sales database 116 is configured to store sales data. In some examples, sales data can be classified as item level sales data. In other examples, sales data can be classified as category sales data. In some implementations, sales data can be associated with an identified retail customer. In other implementations, sales data can be associated with a plurality of retail customers.

The recommendation system 114 operates within the enterprise information system 110 to identify sales associated with a user and select one or more of a plurality of items included in the identified sales to be recommended to the user for repurchase. In the example illustrated in FIG. 1, the recommendation system 114 is in data communication with webserver 112 and enterprise sales database 116. For example, in response to a data received from webserver 112, the recommendation system 114 can send a request to enterprise sales database 116 for sales associated with an identified retail customer. Using data received from the enterprise sales database 116, the recommendation system 114 can identify one or more items to be recommended for repurchase. The recommendation system 114 may output the one or more items to be recommended for repurchase to the webserver 112 such that they can be displayed to the identified customer. For example, the recommendation system can identify one or more items to be recommended for repurchase in response to a receiving a retail website request of a retail customer at a timepoint and the recommended items are selected based on a high probability that the retail customer will select or purchase the items at the timepoint.

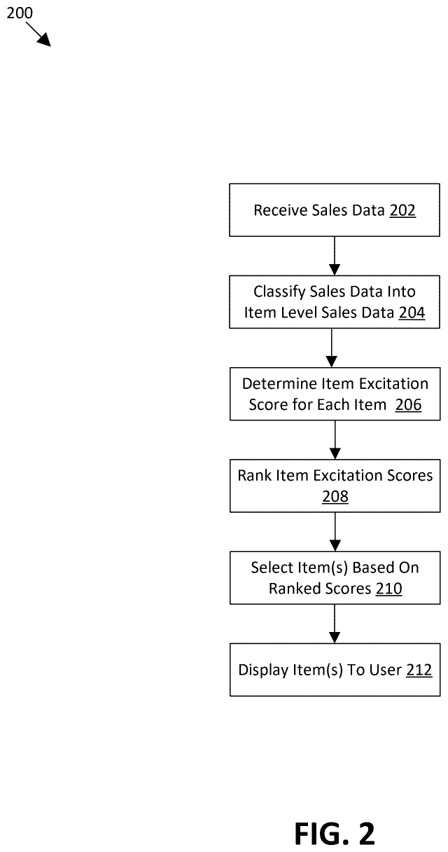

Methods and systems for determining one or more items to be recommended for repurchase will be described with reference to FIGS. 2-4. In some implementations, these systems and methods can generate recommendations in an offline batch mode. In other implementationshese systems and methods are capable of generating recommendations in real-time, as a retail customer is shopping on a website or mobile application. Advantageously, this real-time approach eliminates the need to pre-generate recommendations for countless numbers of customers beforehand, in batch mode. Instead, recommendations can be generated solely for active users. Besides the computational savings, leveraging recent purchases and add-to-cart actions across a general database including historical data of all retail customers of a retail enterprise still enables the ability to generate precise and efficient recommendations.

Furthermore, with respect to the methods and systems described with reference to FIGS. 2-4, the approach taken by the recommendation system 112 allows for an item excitation score or overall item excitation score be determined without collaborative filtering. In fact, this simplified approach has significant technical advantages over existing systems due to an ability to be scaled with large data sets and reduce computational resource requirements. Further, in some implementations, filters can be applied to even further enhance the model's speed and efficiency. For example, because this is an item-based recommendation system, by applying one or more item or category-level filters, especially early in the process, the model's speed and capacity to generate outputs can be further enhanced.

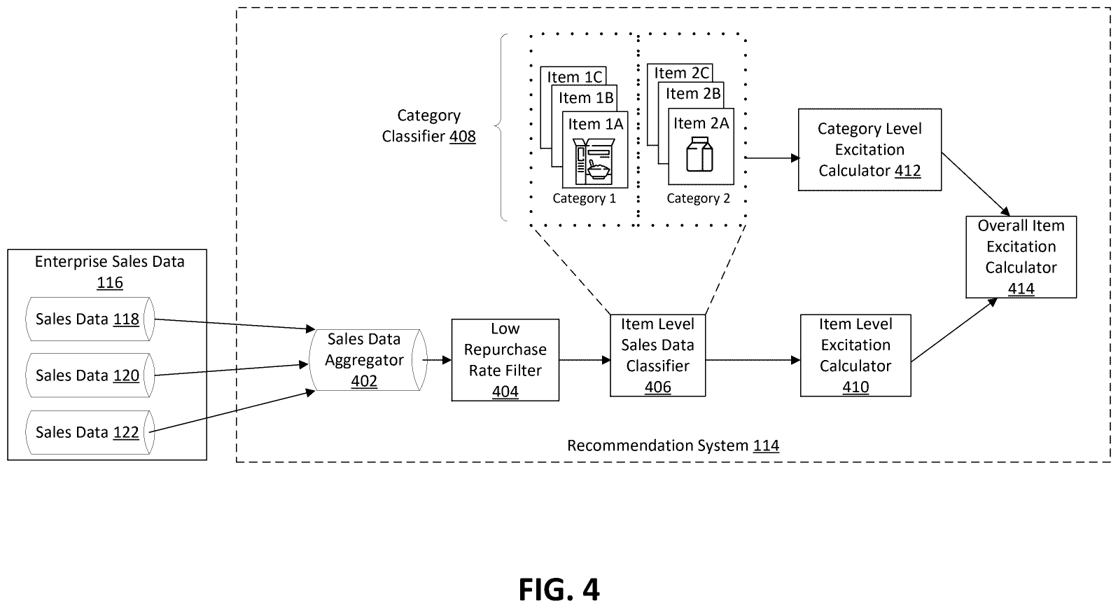

Referring to FIG. 2 a flow chart of an example method 200. In some embodiments, operations of method 200 may be performed by components of the recommendation system 114 as will be further illustrated and described with reference to FIG. 4 In some embodiments, the recommendation system 112 may perform method 200 to select items to be displayed to a user for repurchase.

In the example shown, the recommendation system 112 may receive sales data (step 202). For example, the recommendation system 112 may receive sales data from the enterprise sales database 116 as described with respect to FIG. 1. In some implementations, the sales data may be associated with a retail customer identified as a visitor of a retail website. In some embodiments, the recommendation system 112 can receive sales data in real-time in response to receiving a request from a retail website to display an item recommendation.

In the example shown, the recommendation system 112 may classify sales data into item level sales data (step 204). For example, the recommendation system 112 may classify item level sales data by identifying all individual items that a customer has purchased at least once. In some implementations, the recommendation system 112 may further classify item level sales data by identifying all purchases of an individual item that a customer has purchased at least once. In some embodiments, a filter may be utilized to eliminate items with low repurchase rates. In some examples, a filter may be utilized to eliminate items that have never been repurchased before. In other examples, a filter may be utilized to eliminate items that have been purchased two times or less on average, per customer, across all customers.

In the example shown, the recommendation system 112 may determine an item-level excitation score for each item included in the item level sales data (step 206). In some examples, determining an item excitation score can include a determining item short-term repurchase factor modeled as modeled as an exponential distribution. In other implementations, determining an item excitation score can include determining item long-term repurchase factor modeled as a Gaussian mixture distribution. In some embodiments determining an item-level excitation score can include combining an item short-term repurchase factor and an item long-term repurchase factor.

In some examples, the recommendation system 112 may use an item-specific exponential distribution with parameter (λ) to model the short-term temporal characteristics of self-excitation. In some examples, the item-specific exponential distribution may vary with an inter-purchase time interval (Δt=t−t′). In some implementations, a Gaussian distribution with a mean (μ) and a standard deviation (σ) may be used to model the long-term temporal effect of each item. For example, the item-level excitation score may be determined using the following:

$$item level excitation = {α}_{i} {\sum }_{( {t}^{′} , {i}^{′} ) ∈ {S}_{t}^{g}} I ( {i}^{′} = i ) {γ}_{i} ( t - {t}^{′} )$$

In some implementations the self-excitation values of each item can be interpreted as repurchase scores, where higher values indicate a higher probability that customers will purchase the items at time t. In this example equation, the component I indicates a purchase of an item and equals 1 when the item was previously purchased by the customer g and is 0 otherwise. In this equation, γ is a self-excitation kernel for the item and can be defined as:

$${γ}_{i} ( Δ t ) = {π}^{i} E ( Δ t \vert 1 / {β}^{i} ) + ( 1 - {π}^{i} ) ) N ( δ t \vert {μ}^{i} , {σ}^{i} )$$

This example equation can be used be used to control the temporal characteristics of self-excitation for an item. For example, the self-excitation kernel will vary with the inter-purchase time interval Δt=t−t′.

In the above equations, one or more of the parameters can be tuned to more accurately define the item-level excitation score. For example, parameters α, β, μ, σ and coefficient π can be learned during model training to identify the proper excitation score for an item. In some examples, an Adam optimizer can be used to facilitate efficient parameter learning.

In the example shown, the recommendation system 112 may rank the item excitations scores (step 208). For example, each item from the item-level sales data may be associated with an overall item excitation score. In this manner, the repurchase probability for each of the items purchased by a retail customer can be individually ranked. For example, the item with the item excitation score associated with highest repurchased probability can be ranked first. For example, all items can be ranked by their intensity values, λg,i (t), as determined using the equation above.

In the example shown, the recommendation system 112 may select one or more items based on the ranked scores (step 210). For example, one or more items purchased by a retail customer can be selected based on the ranked item excitation scores.

In the example shown, the recommendation system 112 may display one or more items within a retail website for repurchase by the retail customer (step 212). Examples of displaying items for repurchase are illustrated and described in further detail with respect to FIGS. 7 and 8.

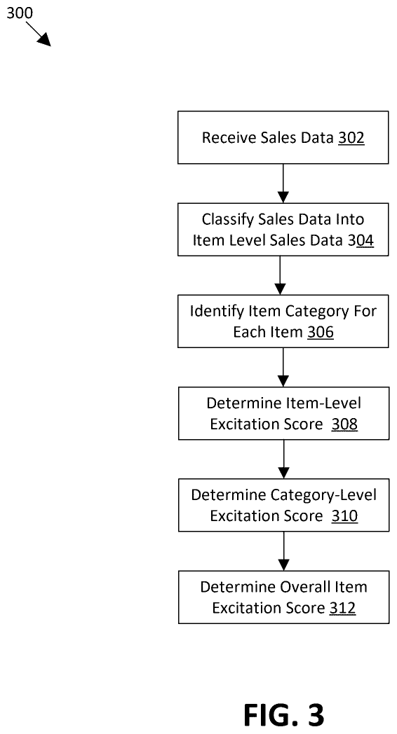

Referring to FIG. 3, is a flowchart of an example method 300. In some embodiments, operations of method 300 may be performed by components of the recommendation system 114 as will be further illustrated and described with reference to FIG. 4. In some embodiments, the recommendation system may perform method 300 to determine an overall item excitation score.

In the example shown, the recommendation system 112 may receive sales data (step 302). For example, the recommendation system 112 may receive sales data from the enterprise sales database 116 as described with respect to FIG. 1. In some implementations, the sales data may be associated with a retail customer identified as a visitor of a retail website. In some embodiments, the recommendation system 112 can receive sales data in real-time in response to receiving a request from a retail website to display an item recommendation. For example, by identifying sales data associated with an identified customer, the recommendation system can be configured to only recommend items for repurchase that have been previously purchased by a customer. In some implementations, in response to receiving sales data indicating that an individual customer has purchased an item, the recommendation system 112 may receive historical sales data associated with all customers who have purchased that item to determine whether to recommend the item to the individual customer for repurchase. In other implementations, the recommendation system 112 may be further configured to determine when to recommend the item for repurchase based on historical sales data across all customers.

For example, a repurchase rate can be identified for an item based on historical sales across all customers. In this manner, the purchasing behavior of a large population of customers is applied to determine recommendations rather than the purchasing behavior of a single customer. In some embodiments, the repurchase rate determined across all customers will be used even if it differs from the repurchase rate for an identified customer. By deriving recommendations based on general purchasing patterns seen by a large population of customers, the use of collaborative filtering can be eliminated, thereby resulting in greater efficiency and scalability of the recommendation system 112. In the example shown, the recommendation system 112 may classify sales data into item level sales data (step 304). For example, the recommendation system 112 may classify item level sales data by identifying all individual items that a customer has purchased at least once. In some implementations, the recommendation system 112 may further classify item level sales data by identifying all purchases of an individual item that a customer has purchased at least once.

In some embodiments, classifying sales data into item level sales data further includes applying a filter to the item level sales data to eliminate items with low repurchase rates. For example, after a customer has purchased an item, the recommendation system 112 can be configured to determine if an item is a frequently repurchased item. In some implementations, a frequently repurchased item can be an item that has been purchased at least twice by all customers that have previously purchased that item. In some implementations, a filter can eliminate items that have not been purchased more than once across all customers. In some implementations, if an item has never been purchased more than once across all customers, then the item will be eliminated. In other instances, a filter can be applied to only consider items that have been repurchased by a specified number of customers at least a specified number of times. For example, a filter can be applied such that only items that have been repurchased by X number of customers at least Y number of times are considered. In other examples, a filter can eliminate items that less than X customers have repurchased at least Y number of times. For example, a filter can eliminate items that less than 100 customers have repurchased at least one time. In other examples, a filter can eliminate items that less than 1000 users have repurchased at least one time. In still other examples, a filter can eliminate times that fewer than 1000 users have repurchased at least three times.

In the example shown, the recommendation system 112 may identify an item category for each item included in the item level sales data (step 306). In some implementations, the recommendation system 112 may further identify subcategories for each item included in the item level sales data. In some embodiments, one or more categories or subcategories can be identified for each item. For example, the recommendation system 112 may identify a 6 oz vanilla yogurt item as being categorized as a grocery item. In other examples, the recommendation system may further identify a 6 oz vanilla yogurt item as being categorized as a yogurt item. In still other examples, the recommendation system may further identify a 6 oz vanilla yogurt item as being a dairy item.

In the example shown, the recommendation system 112 may determine an item-level excitation score (step 308). In some embodiments, an item-level excitation score can be associated with a recurring repurchase rate that is associated with the item based on historical sales data across all customers. For example, an item-level excitation score can be used to determine when to recommend an item for repurchase to a customer. In some examples, determining an item-level excitation score can include a determining item short-term repurchase factor modeled as modeled as an exponential distribution. In other implementations, determining an item-level excitation score can include determining an item long-term repurchase factor modeled as a Gaussian mixture distribution. In some embodiments determining an item-level excitation score can include combining an item short-term repurchase factor and an item long-term repurchase factor. In some examples, the item-level excitation score may be determined by using an item-specific exponential distribution with parameter (λ) to model the short-term temporal characteristics of self-excitation. In some examples, the item-specific exponential distribution may vary with an inter-purchase time interval (Δt=t−t′). In some implementations, a Gaussian distribution with a mean (μ) and a standard deviation (σ) may be used to model the long-term temporal effect of each item. For example, the item-level excitation score may be determined using the following:

$$item - level excitation = {α}_{i} {\sum }_{( {t}^{′} , {i}^{′} ) ∈ {S}_{t}^{g}} I ( {i}^{′} = i ) {γ}_{i} ( t - {t}^{′} )$$

In some implementations the self-excitation values of each item can be interpreted as repurchase scores, where higher values indicate a higher probability that customers will purchase the items at time t. In this example equation, the component/indicates a purchase of an item and equals 1 when the item was previously purchased by the customer g and is 0 otherwise. In this equation, y is a self-excitation kernel for the item and can be defined as:

$${γ}_{i} ( Δ t ) = {π}^{i} E ( Δ t \vert 1 / {β}^{i} ) + ( 1 - {π}^{i} ) ) N ( δ t \vert {μ}^{i} , {σ}^{i} )$$

This example equation can be used be used to control the temporal characteristics of self-excitation for an item. For example, the self-excitation kernel will vary with the inter-purchase time interval Δt=t−t′. In this equation, one or more of the parameters can be tuned to more accurately define the item-level excitation score. For example, the parameters α, β, μ, σ and coefficient π can be learned during model training to identify the proper excitation score for an item. In some examples, an Adam optimizer can be used to facilitate efficient parameter learning.

In the example shown, the recommendation system 112 may determine a category-level excitation score (step 310). In some embodiments, a category-level excitation score can represent a repurchase rate for a predetermined category determined across historical purchases made by all customers. For example, a category-level excitation score can be used to determine when to recommend an item to a customer for repurchase based on the repurchase rate associated with the item's predetermined category. In some examples, the repurchase rate for a category can be different than the repurchase rate of an item belonging to the category. For example, determining a category-level excitation score can include determining a category short-term repurchase factor modeled as an exponential distribution. In other examples, determining a category-level excitation score can include determining a category long-term repurchase factor modeled as a Gaussian mixture distribution. In some embodiments, determining a category-level excitation score can include determining both a category short-term repurchase factor and a category-level long-term repurchase factor. For example, the category-level excitation score can be determined using the following:

$$category - level excitation = {β}_{i} {\sum }_{( {t}^{′} , {i}^{′} ) ∈ {S}_{t}^{g}} J ( {i}^{′} = i ) {Γ}_{i} ( t - {t}^{′} )$$

In this example equation, component/indicates a purchase within a category and equals 1 for timestamps when an item in the same category was previously purchased and 0 otherwise. In the example equation, Γ is a self-excitation kernel for the category and can control the temporal characteristics of self-excitation, varying with the inter-purchase time interval Δ t=t−t′. For example, Γ can be defined as:

$${Γ}_{i} ( Δ t ) = {Π}^{i} E ( Δ t \vert 1 / {η}^{i} ) + ( 1 - {Π}^{i} ) ) N ( Δ t \vert {ζ}^{i} , {Σ}^{i} )$$

In the example equation, one or more of the parameters can be tuned to more accurately identify category-level excitation scores. For example, the parameters β, η, ζ, Σ and coefficient Π can be learned during model training to identify the proper excitation score for an item.

In the example shown, the recommendation system 112 may determine an overall item-level excitation score for an item (step 312). For example, an overall item excitation score can be used to determine when to recommend an item to a customer for repurchase based on historical purchase data aggregated across all customers. For example, an overall item-level excitation score can be based on both an item-level excitation score and a category-level excitation score. In some embodiments, the recommendation system 112 may further rank the overall item excitations scores such that the overall item excitation score associated with the highest repurchased probability can be ranked first. For example, the overall item excitation score can be determined using the following:

$${λ}^{g , i} ( t ) = {α}_{i} {\sum }_{( {t}^{′} , {i}^{′} ) ∈ {S}_{t}^{g}} I ( {i}^{′} = i ) {γ}_{i} ( t - {t}^{′} ) + {β}_{i} {\sum }_{( {t}^{′} , {i}^{′} ) ∈ {S}_{t}^{g}} J ( {i}^{′} = i ) {Γ}_{i} ( t - {t}^{′} )$$

In this example equation, the overall item excitation score, λ^{g,i} (t), refers to the intensity of repurchase of a customer g at a time t and is equal to a summation of the self-excitation of all previous purchases of item i. In the example equation, the item level excitation score (calculated in step 310) and the category level excitation score (calculated in step 308) are added together. In some implementations, all candidate items can be ranked by their overall item excitation score. For example, by ranking all items by their overall item excitation score, the recommendation system 112 can determine a prioritized list of one or more items to recommend to a customer for repurchase. Referring to FIG. 4, is a block diagram of an example architecture of aspects of a recommendation system 114 usable within a retail enterprise. The recommendation system 114 implements an efficient architecture for determining overall item excitation based on enterprise sales data. As illustrated in FIG. 4, the recommendation system 114 includes a sales data aggregator 402, a low repurchase rate filter 404, an item-level sales data classifier 406, a category classifier 408, an item-level excitation calculator 410, a category-level excitation calculator 412, and an overall item excitation calculator 414.

Recommendation system 114 can be configured to determine one or more items to recommend to a customer for repurchase in real-time based on historical customer purchase data, across all customers. For example, recommendation system 114 can be configured to determine in real-time whether historical customer data indicates that the item is purchased on a regular or semi-regular basis. In some embodiments, once a customer has purchased an item, recommendation system 114 can be configured to determine whether to recommend repurchasing that item to the customer in real-time. In other embodiments, recommendation system 114 can be configured to recommend repurchasing an item at a time that has been determined, across all customers, to be associated with a high likelihood of repurchasing an item. For example, a time that is associated with a high likelihood of repurchasing an item can be determined in real-time based on a repurchasing pattern for the item or category that has been identified based on aggregated historical sales data across all customers. In other examples, a repurchasing pattern can be a repurchasing rate that has been determined based on aggregated historical customer data. In some implementations, recommendation system 114 can select one or more items from sales data associated with a given customer to recommend for repurchase in real-time based on a ranking of overall item excitation scores determined based on aggregated purchase data across all customers.

Enterprise sales database 116 includes all data associated with purchases made at a retail enterprise over a given period of time. For example, enterprise sales data 116 can include all of the in-store or online purchases at a retail enterprise made the customers of the retail enterprise. As illustrated in FIG. 4, the enterprise sales data 116 can be stored in one or more sales databases 118-122. In some examples, a sales database can correspond to all sales made at an individual physical store of the retail enterprise. In other examples, a sales database can correspond to all sales made by a subset of customers of the retail enterprise. Enterprise sales database 116 can send sales data to the sales data aggregator 402.

Sales data aggregator 402 receives sales data for one or more customers from the enterprise sales database 116. In some embodiments, sales data aggregator 402 receives substantially all of the enterprise sales data for a given time period. For example, sales data aggregator 402 can aggregate historical customer sales data for all identified customers for a given period of time. In some embodiments, identified customers are customers associated with a loyalty account. In some implementations, the sales data aggregator 402 can collect enterprise sales data from a plurality of enterprise sales databases. The sales data aggregator 402 can output sales data to a low repurchase rate filter.

Low repurchase rate filter 404 receives sales data from the sales data aggregator 402. In some examples, the low repurchase rate filter 404 may be configured to filter the sales data received from the sales data aggregator 402. For example, low repurchase rate filter 404 can be configured to eliminate items with low repurchase rates from the sales data. In some implementations, items that have not been purchased a minimum number of times across all users can be filtered by the low repurchase rate filter 404. In other implementations, items that have not been repurchased a minimum number of times across all users can be filtered by the low repurchase rate filter 404. For example, low repurchase rate filter 404 can filter items purchased only N times across all customers. In some examples, low repurchase rate filter 404 can filter items purchased only once across all customers. In other examples, low repurchase rate filter 404 can filter items purchased two times or less across all customers.

As mentioned, the use of early-stage filtering at the low repurchase rate filter 404 to reduce the number of items in the dataset can significantly increase the scalability and computational efficiency of the recommendation system 114. This enhances the ability of the recommendation system to produce recommendations in real-time as a customer is shopping on retail website or mobile application. In some implementations, the filter can be configured to be more selective or additional filters can be applied. For example, in some implementations a filter can be applied that excludes items that have not been repurchased by customers more than a certain number (N) of times within the past 12 months. For example, as N increases, the size of the number of items can be reduced and only the most frequently purchased items will be included. The use of additional truncation, based on N, can further reduce latency to allow for real-time inference of item recommendations.

Item-level sales data classifier 406 receives filtered sales data from the low repurchase rate filter 404. Item-level sales data classifier 406 is configured to group together all sales, across all customers or users, associated with a given item to generate item-level sales data. In some implementations, item-level sales data classifier 406 is configured to send item-level sales data to the item-level excitation calculator 410. In some embodiments, the item-level sales data classifier 406 further includes category classifier 408. In some implementations, the item-level sales data classifier 406 can be further configured to send item-level sales data to category classifier 408.

Category classifier 408 is configured to sort item sales into predetermined categories to generate category level sales data. In some implementations, category classifier 408 receives item level sales data from item level sales classifier 406. For example, category classifier 408 can classify 1A-1C as belonging to category 1. For example, category 1 can include all items corresponding to different types of cereal. Likewise, category classifier 408 can classify items 2A-2C as belonging to category 2. For example, category 2 can include all items corresponding to different types of milk. In some examples, category classifier 408 can be configured to further classify items into subcategories. For example, items in category 2 can be classified into subcategories corresponding to dairy or nondairy milk. In other examples, category classifier 408 can be configured to group different categories of items into general categories. For example, category 1 and category 2, corresponding to cereal and milk, respectively, can be grouped into a general grocery category. In other examples, category 1 and category 2, corresponding to cereal and milk, respectively, can be grouped into a breakfast category. In some embodiments, category classifier 408 is configured to send category level sales data to category level excitation calculator 412.

Item level excitation calculator 410 receives item level sales data from the item level sales data classifier 406. Item level excitation calculator 410 is configured to determine an item-level excitation score for each item in the item level sales data. In some examples, an item-level-excitation score can correspond to a repurchase rate for an item based on historical sales data across all customers. For example, as illustrated in FIG. 4, the item level excitation calculator can determine an item level excitation score each individual item 1A-2C based on aggregated sales data across all customers that have historically purchased the given item. For example, an item level excitation score for item 1A can be determined based on sales data across all customers that have historically purchased item 1A. Likewise, an item level excitation score for item 2A can be determined based on historical sales data across all customers that have purchased item 2A. Examples of determining an item-level excitation score are described with further reference to FIGS. 2 and 3. In some examples, item level excitation calculator 410 can be configured to send item-level excitation scores to the overall item excitation calculator 414.

Category level excitation calculator 412 receives category level sales data from the category classifier 408. Category level excitation calculator 412 is configured to determine a category-level excitation score for each category. In some examples, a category level excitation score can correspond to a repurchase rate for a category. For example, the category level excitation calculator can determine a category-level excitation score for across all items classified as belonging to category 1. For example, the category level excitation score can be determined based on historical sales across all customers that have purchased items belonging to category 1. For example, historical sales of items 1A-1C across all customers can be used to determine an excitation score for category 1. Likewise, the category level excitation calculator can determine a category level excitation score across all items classified as belonging to category 2. For example, aggregated sales data across all customers that have historically purchased items 2A-2C can be used to determine a category level excitation score for category 2. Examples of determining category-level excitation scores are further described with reference to FIG. 3. In some embodiments, category level excitation calculator 412 can be configured to send category-level excitation scores to the overall item excitation calculator.

Overall item excitation calculator 414 receives item-level excitation scores from the item level excitation calculator 410. In some embodiments, overall item excitation calculator 414 further receives category-level excitation scores from the category level excitation calculator 412. In some embodiments, the overall item excitation scores associated with each item is based on the item excitation score. In other embodiments, the overall item excitation scores associated with each item is based on one or more of the item-level excitation scores and the category-level excitation scores. In still other embodiments, the overall item excitation scores associated with each item is based on both the item-level excitation scores and the category-level excitation scores. For example, the overall item excitation score can be a total of an item-level excitation score, and the category-level excitation score determined for a given item. In other examples, the overall item excitation score can be the product of an item-level excitation score and a category-level excitation score. In some examples, if an item is not associated with a category, then the overall item excitation score will be based solely on the item-level excitations score. Determining an overall item excitation score is described in further detail with reference to FIG. 3.

In some examples, the overall item excitation calculator 414 can rank the overall item excitation scores for one or more items. For example, the overall item excitation calculator 404 can rank the overall item excitation scores for the items previously purchased by a customer to determine which items to recommend to a customer for repurchase in real-time. For example, the highest ranked overall item excitation score can correspond to the item most likely to be repurchased. For example, in response to receiving a request to generate an item recommendation for a customer the recommendation system 114 can efficiently and accurately identify and rank items previously purchased by the customer based on the overall item excitation scores for those items, wherein the overall item excitation scores are determined based on historical purchase data aggregated across all customers that have also purchased those items. Displaying recommended items based on overall item excitation scores will be illustrated and described in further detail with respect to FIGS. 7 and 8.

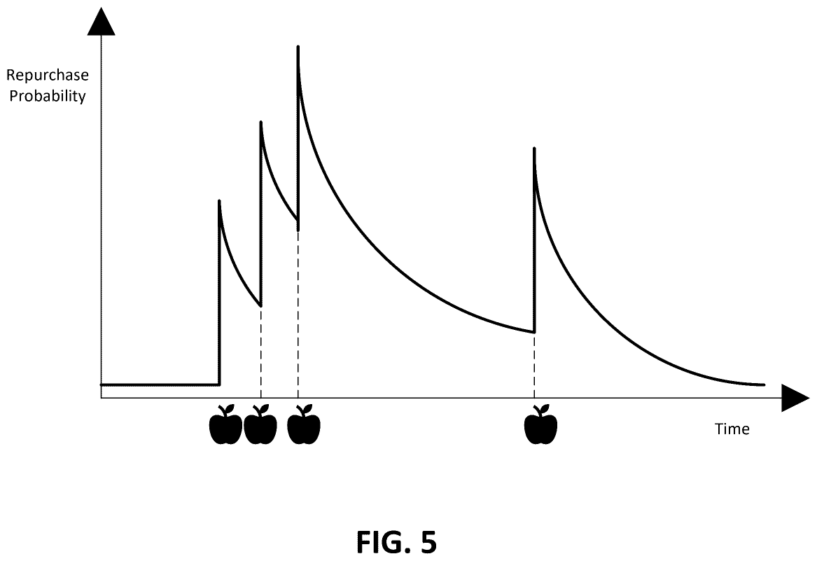

Referring to FIG. 5 illustrates modeling a short-term repurchase probability for an item using an exponential distribution. For example, as shown in FIG. 5, the likelihood of purchasing an item again changes over time since the last time the item was purchased. As shown in the example, an excitation event occurs every time an item is purchased, and each subsequent purchase contributes to the overall likelihood of a customer purchasing the item. The level of excitation can be interpreted as a repurchase score, where a higher value indicates a higher probability that customers will purchase the item at a given time. This provides insights into customer behavior and enables effectively capturing repeat-purchase patterns for many items, for example, apples, as shown in FIG. 5, and other items that are generally repurchased over a short period of time.

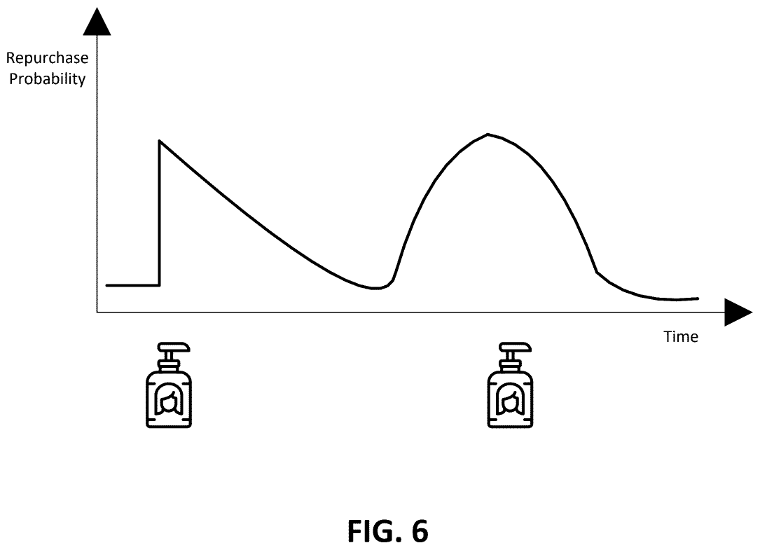

Referring now to FIG. 6, a different approach may be taken to further optimize capturing repeat-purchase patterns for items that are generally repurchased over a short period of time and also capture repurchase probability for other items with various repurchase rates. For example, for some items having longer repurchase cycles, such as shampoo, as illustrated in FIG. 6, it is possible to more accurately determine repurchase probability by modeling both short-term and long-term repurchase patterns by combining exponential and normal distributions. By identifying and more accurately modeling repurchase probability for items or categories with more sporadic or long-term repurchase rates, it is possible to provide alternate strategies for capturing customer repurchase probability in these items or categories and more accurately offer valuable repurchase insights. For example, by identifying a repurchase pattern associated with the item, a repurchase recommendation can be made at am appropriate time that will increase the likelihood that the recommended item will be selected by the customer for repurchase. For example, unlike some frequently repurchased items, such as bread or produce, a customer would not be likely to respond to a recommendation to buy shampoo again within days of an original purchase. However, by adding a normal distribution to capture the long-term repurchase pattern of the item or category to the short term repurchase effect captured by the exponential distribution, it is possible to better capture repurchase patterns for items or categories with various repurchase rates. In this manner, a customer can be provided with a recommendation to repurchase, for example, shampoo at a time that has been found, across all users, to be associated with a high probability of repurchase. By addressing various repurchase rates, valuable insights for customer repurchase strategies can be provided, including reminding a customer to repurchase an item that is likely to be running out soon.

As will be illustrated and described with respect to the examples shown in FIGS. 7 and 8, the systems and methods described above can be implemented to display recommended items to a user in a variety of different user interfaces. In particular, these user interfaces can display recommended items in a convenient, interactive manner that further increases user convenience and engagement with the retail website. In some implementations, the components illustrated and described with respect to these user interfaces can be interchangeable. In some implementations, only a subset of the components illustrated and described with respect to these user interfaces may be implemented.

In general, the user interfaces illustrated in FIGS. 7 and 8 may be displayed to a retail customer in response to a retail customer visiting a retail website or mobile application. For example, real-time inferencing discussed with reference to FIGS. 2-4 can occur in response to the retail customer visiting the retail website or mobile application. For example, rather than precomputing item excitation values or other precomputations, the item recommendations are determined in real-time such that one or more item recommendations can be displayed to a retail customer in response to the retail customer visiting the retail website or mobile application. While this use of real-time inferencing requires faster decision making, as described with respect to FIGS. 2-4, the systems and methods used to make these real-time inferences are able to significantly reduce computational complexity by calculating excitation values across all users for items that were previously purchased by the retail customer identified as a visitor of a retail website.

FIG. 7 illustrates a user interface, according to an example embodiment. The example of FIG. 7 includes a computing device 700 displaying an example user interface 702. For example, computing device 700 may display a user interface 702 to a user. For example, computing device may be a device used by the user 102, 104, or 106. In some embodiments, one or more components of the user interface 702 may be part of other user interfaces associated with the enterprise information system 110. Furthermore, the user interface 702 may include more or fewer components than those illustrated in FIG. 7.

The computing device 700 may be any device operable by a user to interact with the network 108, as illustrated and described with respect to FIG. 1. The computing device 700 may be, for example, a mobile device, a tablet, a desktop device, a smart watch, or another wired or wireless computing device with a user interface.

As described above, the example user interface 702 may be displayed on the computing device 700. In some examples the user interface 702 may be an interface of a retail website that is associated with the enterprise information system 110. In other examples, the user interface 702 may be an interface of a mobile application that is associated with the enterprise information system 110. In some embodiments, the user interface 702 can be displayed to an identified retail customer. For example, the user interface 702 can be displayed to the user in response to the user entering their login credentials. In the example shown, the user interface 702 includes a plurality of components including example recommended items 704-710.

Recommended items 704-710 can be displayed according to the systems and methods described with respect to FIGS. 1-4. In some embodiments, recommended items 704-710 may be selected from a list of recommended items based on sales associated with the user. For example, recommended items 704-710 can be the highest ranked items selected from a ranked list of recommended items. In some implementations, recommended items 704-710 may be displayed in a ranked order. For example, recommended items 704-710 may be displayed in a ranked order with the item that is the most likely to be repurchased being displayed first. For example, recommended item 704 may be displayed first because it is the most likely to be repurchased based on an item-level excitation score. In other examples, recommended item 704 may be displayed first based on an overall item excitation score. In other implementations, recommended items 704-710 may be displayed in a ranked order with the categories that are most likely to be repurchased being displayed first. For example, recommended item 704 may be displayed first because it is associated with a category that is most likely to be repurchased based on a category-level excitation score. As shown in FIG. 7, in some embodiments, the recommended items 704-710 may further include a button allowing a user to conveniently add the item to their cart.

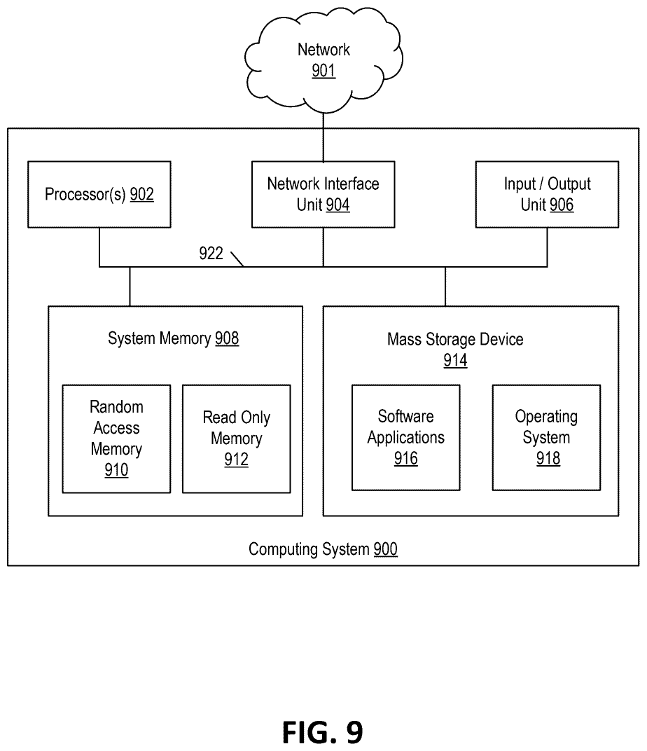

Referring now to FIG. 8 is another example user interface. The example of FIG. 8 includes a computing device 800 displaying an example user interface 802. For example, the computing device may display a user interface 802 to a user. In some embodiments, one or more components of the user interface 802 may be part of other interfaces associated with the enterprise information system 110. Furthermore, the user interface may include more or fewer components than those illustrated in FIG. 9

In some examples, the user interface 802 may be an interface of a retail website or mobile application that is associated with the enterprise information system 110. In some embodiments, the user interface 802 can be displayed to an identified retail customer. For example, the user interface 802 can be displayed to the user in response to the user entering their login credentials. In the example shown, the user interface 802 includes a plurality of components including a category region 806, an item recommendation carousel 808, and example recommended items 810-812.

The category region 806 may include one or more selectable categories or subcategories. In the example shown, the category region includes a selectable category icon for Grocery, Clothes, Home, Toys, Office, and Health. In some embodiments, the user interface 802 may display one or more recommended items in response to a user selecting one of the categories. As such, a relevant, subset of recommended items can be conveniently displayed to a user as they browse a specific category, thus streamlining the user experience.

The item recommendation carousel 808 can display one or more recommended items. In some embodiments, the item recommendation carousel 808 can be configured as a scrollable list of recommended items. For example, a user can scroll through the recommended items contained in the item recommendation carousel 808. In some embodiments, all recommended items identified for the user that are associated with the category that the user is browsing can be included in the item recommendation carousel as recommended category items. In some implementations, the recommended category items can be displayed in a ranked order. For example, a ranked order may be determined based on item-level excitation scores. In other examples, a ranked order may be determined based on overall item excitation scores. For example, the highest ranked item can be displayed first, and the user can scroll through all ranked items until reaching the last ranked items. In some embodiments, after the user reaches the last ranked item, the first ranked item can be shown again such that the use can cycle through the recommended items in the item recommendation carousel again.

In some embodiments, a user can select an item to view additional item details. In other implementations, a user can select a subset of the recommended category items to be saved to a shopping list for future online or in-store shopping. In other examples, a user can save a subset of the recommended items to a folder of favorite items associated with their account. In some implementations, the user can select an item to add the item to their basket. For example, in response to selecting an item category, a user can simultaneously view one or more of their recommended category items while selecting a subset of the recommended category items to be added to their shopping cart. For example, a user can select a subset of the recommended category items to be added to their shopping cart for pickup or delivery. In this manner, a user can conveniently browse, identify, and repurchase items on a category-by-category basis depending on their unique needs or interests. For example, as shown in the example implementation illustrated in FIG. 8, a user can quickly view and add frequently repurchased grocery items to their shopping cart in response to simply selecting the Grocery category.

FIG. 9 illustrates an example block diagram of a virtual or physical computing system 100. One or more aspects of the computing system 100 can be used to implement the processes described herein.

In the embodiment shown, the computing system 900 includes one or more processors 902, a system memory 908, and a system bus 922 that couples the system memory 908 to the one or more processors 902. The system memory 908 includes RAM (Random Access Memory) 910 and ROM (Read-Only Memory) 912. A basic input/output system that contains the basic routines that help to transfer information between elements within the computing system 900, such as during startup, is stored in the ROM 912. The computing system 900 further includes a mass storage device 914. The mass storage device 914 is able to store software instructions and data. The one or more processors 902 can be one or more central processing units or other processors.

The mass storage device 914 is connected to the one or more processors 902 through a mass storage controller (not shown) connected to the system bus 922. The mass storage device 914 and its associated computer-readable data storage media provide non-volatile, non-transitory storage for the computing system 900. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 900.

According to various embodiments of the invention, the computing system 100 may operate in a networked environment using logical connections to remote network devices through the network 901. The network 901 is a computer network, such as an enterprise intranet and/or the Internet. The network 901 can include a LAN, a Wide Area Network (WAN), the Internet, wireless transmission mediums, wired transmission mediums, other networks, and combinations thereof. The computing system 900 may connect to the network 901 through a network interface unit 904 connected to the system bus 922. It should be appreciated that the network interface unit 904 may also be utilized to connect to other types of networks and remote computing systems. The computing system 900 also includes an input/output controller 906 for receiving and processing input from a number of other devices, including a touch user interface display screen, or another type of input device. Similarly, the input/output controller 106 may provide output to a touch user interface display screen or other type of output device.

As mentioned briefly above, the mass storage device 914 and the RAM 910 of the computing system 900 can store software instructions and data. The software instructions include an operating system 918 suitable for controlling the operation of the computing system 900. The mass storage device 914 and/or the RAM 910 also store software instructions, that when executed by the one or more processors 902, cause one or more of the systems, devices, or components described herein to provide functionality described herein. For example, the mass storage device 914 and/or the RAM 910 can store software instructions that, when executed by the one or more processors 902, cause the computing system 900 to receive and execute managing network access control and build system processes.

The disclosed computing system provides a physical environment with which aspects of the recommendation system described herein may be implemented. It is noted that the disclosure computing system may be used to implement a recommendation computing system, a retail website server, one or more cloud servers used to provide associated services, database servers storing item information, or end-user devices, such as a personal computing system having a browser installed thereon, or a mobile device having either a browser or mobile application installed therein. It is in this environment that scalability of recommendations is essential to achieve real-time recommendation generation for a particular user.

Techniques of the recommendation system 11 have been empirically compared to prior techniques for generating repurchase recommendations. For example, the performance of recommendation system 112 was compared against existing methods using three publicly available datasets: ValuedShopper (VSh.), Instacart (Ins.), and Dunnhumby (Dun.). The performance of Recommendation System 112 and the existing methods were quantitatively evaluated according to Recall and Normalized Discounted Cumulative Gain (NDCG). Recall quantifies the proportion of purchased items correctly ranked among the top-K recommendations across all testing sessions. NDCG, a ranking measure, evaluates the order of recommended items, producing a score from 0 to 1.

As shown in Table 1, the existing models that the recommendation system 112 was compared against include: A model that recommends the most frequently purchased items to all customers (TopSell); A model that recommends the most frequently purchased items to individual customers (FBought); A RNN-based model for session-based recommendation, capturing repeated purchase behavior using GRUs and attention mechanisms (RepeatNet); A state-of-the-art end-to-end method for predicting multiple baskets based on RNN, integrating repeated purchase patterns (Sets2Sets); A model that utilizes a Poisson Gamma distribution to predict aggregate purchasing behavior (PG); A modified version of PG model that considers time dependency and repeat customer probability (MPG); A model that utilizes item frequency-based nearest neighbor approach (KNN) to learn repurchasing patterns from other customers (TIFUKNN); A collaborative filtering-based approach based on user wise item popularity and its recency (UPCP); A deep neural network model that learns item relationships by constructing a co-occurrence graph and performs graph convolutions on the dynamic relationship graphs (DNNTSP); A deep neural network (LSTM) based model using user-item representations (ReCANet); A model that uses a hierarchical architecture for personalized recommendations, incorporating survival models and ARIMA to understand consumption rates and temporal trends (PCIC); And a model that integrates collaborative filtering and the Hawkes process for recommendation (SLRC).

TABLE 1
Quantitative Evaluation of Accuracy
of Recommendation System 112

| | Recall@10 | | | NDGC@10 | | |
|---|---|---|---|---|---|---|
| | VSh. | Ins. | Dun. | VSh. | Ins. | Duns. |
| TopSell | 0.10 | 0.07 | 0.08 | 0.08 | 0.06 | 0.06 |
| Fbought | 0.21 | 0.34 | 0.19 | 0.21 | 0.36 | 0.18 |
| RepeatNet | 0.10 | 0.21 | 0.13 | 0.01 | 0.02 | 0.15 |
| Sets2Sets | 0.13 | 0.30 | 0.21 | 0.16 | 0.35 | 0.21 |
| PG | 0.17 | 0.24 | 0.13 | 0.07 | 0.13 | 0.04 |
| MPG | 0.18 | 0.22 | 0.08 | 0.07 | 0.12 | 0.05 |
| TIFUKNN | 0.22 | 0.34 | 0.15 | 0.21 | 0.33 | 0.14 |
| UPCP | 0.22 | 0.34 | 0.14 | 0.21 | 0.33 | 0.14 |
| DNNTSP | 0.19 | 0.34 | 0.09 | 0.20 | 0.33 | 0.08 |
| ReCANet | 0.23 | 0.36 | 0.16 | 0.22 | 0.35 | 0.15 |
| PCIC | 0.35 | 0.25 | 0.15 | 0.35 | 0.57 | 0.23 |
| SLRC | 0.48 | 0.54 | 0.30 | 0.53 | 0.60 | 0.32 |
| Recommendation | 0.45 | 0.69 | 0.29 | 0.51 | 0.60 | 0.25 |
| System 112 | | | | | | |

Table 1 quantitatively evaluates the performance of the recommendation system 112 compared to twelve representative state of the art models, with the top two performing models bolded. Table 1 illustrates that the recommendation system 112 is able to outperform nearly all of the previous systems. The recommendation system 112 and the SLRC model are fairly even in performance across the datasets. However, as illustrated in Table 2, below, due to the complexity of the collaborative filtering utilized by the SLRC model, scaling the SLRC model to a full, internal enterprise data set proved impractical.

TABLE 2
Quantitative Evaluation of Efficiency
of Recommendation System 112

| | Time to Train Model | |
|---|---|---|
| | 1% Enterprise Dataset | 100% Enterprise Dataset |
| SLRC | 13 hours | 1300 hours |
| Recommendation | 2-3 hours | 250 hours |
| System 112 | | |

As shown in Table 2, when compared to the other top performing recommendation system in term of accuracy, the recommendation system 112 is able to far more efficiently train and generate recommendations. As illustrated in Table 2, recommendation system 112 can be trained on an entire enterprise dataset in a fraction of the amount of time that it takes SLRC, due to the collaborative filtering implementation used in SLRC. This further illustrates that, in addition to its accuracy, recommendation system 112 presents further technical advantages over existing models because of its ability to be scaled with large data sets and reduce computational resource requirements due to its simplified approach.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of recommendation systems, technologies disclosed herein are applicable to data and methods for determining display of items at a retail website generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

We claim:

1. A method of generating an item recommendation to a user, the method comprising:
identifying sales associated with a retail customer identified as a visitor of a retail website;
classifying the sales into item level sales data;
for each item included in the item level sales data, identifying an item category;
for each item included in the item level sales data, determining an overall item excitation score, wherein determining the overall item excitation score includes:
determining an item-level excitation score including an item short-term repurchase factor modeled as an exponential distribution and an item long-term repurchase factor modeled as a Gaussian mixture distribution;
determining a category-level excitation score including a category short-term repurchase factor modeled as an exponential distribution and a category long-term repurchase factor modeled as a Gaussian mixture distribution; and
determining the overall item excitation score for the item based on one or more of the item-level excitation score and the category-level excitation score;
ranking a plurality of generated overall item excitation scores, each associated with a different item from among the item level sales data; and
selecting one or more of the plurality of items included in the retail item collection based on the ranked overall item excitation scores; and
displaying the one or more of the plurality of items within a retail website for purchase by the retail customer.

2. The method of claim 1, wherein determining an overall item excitation score is performed in real-time in response to receiving a retail website request of a retail customer to display a web page that includes an item recommendation carousel.

3. The method of claim 1, wherein determining the overall item excitation score is performed without collaborative filtering.

4. The method of claim 1, wherein classifying the sales into item level sales data further includes applying a filter to eliminate items with low repurchase rates.

5. The method of claim 1, wherein determining the overall item excitation score for the item is based on both the item-level excitation score and the category-level excitation score.

6. The method of claim 1, wherein determining the item-level excitation score includes identifying historical sales data across all retail customers of a retail enterprise such that the item-level excitation score is based on the historical sales data of the item across all retail customers of a retail enterprise.

7. The method of claim 1, wherein determining an overall item excitation score is performed in real-time in response to a receiving a retail website request of a retail customer at a timepoint and a high overall item excitation score indicates a high probability that the retail customer will purchase an item at the timepoint.

8. A system for generating an item recommendation to a user, the system comprising:
a data repository configured to store sales data associated with a retail customer identified as a visitor of a retail website;
a recommendation system in data communication with the data repository and a plurality of client computing devices, wherein the recommendation system is configured to:
classify the sales data into item level sales data;
for each item included in the item level sales data, identify an item category;
for each item included in the item level sales data, determine an overall item excitation score, wherein determining the overall item excitation score includes:
determining an item-level excitation score including an item short-term repurchase factor modeled as an exponential distribution and an item long-term repurchase factor modeled as a Gaussian mixture distribution;
determining a category-level excitation score including a category short-term repurchase factor modeled as an exponential distribution and a category long-term repurchase factor modeled as a Gaussian mixture distribution; and
determining the overall item excitation score for the item based on one or more of the item-level excitation score and the category-level excitation score;
rank a plurality of overall item excitation scores, each associated with a different item from among the item level sales data; and
select one or more of the plurality of items included in the retail item collection based on the ranked overall item excitation scores; and
display the one or more of the plurality of items within a retail website for purchase by the retail customer.

9. The system of claim 8, wherein determining an overall item excitation score is performed in real-time in response to receiving a retail website request of a retail customer to display a web page that includes an item recommendation carousel.

10. The system of claim 8, wherein determining the overall item excitation score is performed without collaborative filtering.

11. The system of claim 8, wherein classifying the sales into item level sales data further includes applying a filter to eliminate items with low repurchase rates.

12. The system of claim 8, wherein determining the overall item excitation score for the item is based on both the item-level excitation score and the category-level excitation score.

13. The system of claim 8, wherein determining the item-level excitation score includes identifying historical sales data across all retail customers of a retail enterprise such that the item-level excitation score is based on the historical sales data of the item across all retail customers of a retail enterprise.

14. The system of claim 8, wherein determining an overall item excitation score is performed in real-time in response to a receiving a retail website request of a retail customer at a timepoint and a high overall item excitation score indicates a high probability that the retail customer will purchase an item at the timepoint.

15. A method of generating an item recommendation to a user, the method comprising:
identifying sales associated with a retail customer identified as a visitor of a retail website;
classifying the sales into item level sales data, wherein classifying the sales into item level sales data further includes applying a filter to eliminate items with low repurchase rates;
for each item included in the item level sales data, determining an item-level excitation score based on historical sales data across all retail customers of a retail enterprise, wherein determining the item-level excitation score includes determining item short-term repurchase factor modeled as an exponential distribution and an item long-term repurchase factor modeled as a Gaussian mixture distribution;
ranking a plurality of generated item-level excitation scores, each associated with a different item from among the item level sales data; and
selecting one or more of the plurality of items included in the retail item collection based on the ranked item-level excitation scores; and
displaying the one or more of the plurality of items within a retail website for purchase by the retail customer.

16. The method of claim 15, wherein determining the item-level excitation score is performed in real-time in response to receiving a retail website request of a retail customer to display a web page that includes an item recommendation.

17. The method of claim 15, wherein the web page that includes an item recommendation is associated with a specific category and classifying the sales into item level sales data further includes identifying an item category such that only items associated with the specific category are included in the selection of one or more of the plurality of items in the retail item collection.

18. The method of claim 15, wherein determining the item-level excitation score is performed without collaborative filtering.

19. The method of claim 15, wherein the filter eliminates items that have not been purchased more than once across all customers.

20. The method of claim 15, wherein determining an item-level excitation score is performed in real-time in response to a receiving a retail website request of a retail customer at a given time and a high item excitation score indicates a high probability that the retail customer will purchase an item at the given time.
